(19) United States
(12) Patent Application Publication
(10) Pub. No.: US 2012/0196375 A1
(43) Pub. Date: Aug. 2, 2012

(54) Compositions and Methods for Detection of Soils on Fabrics

(75) Inventors: Mark GRANJA, Danbury, CT (US); Robert Doris, Trumbull, CT (US)

(73) Assignee: The Sun Products Corporation, Wilton, CT (US)

(21) Appl. No.: 13/198,463

(22) Filed: Aug. 4, 2011

Related U.S. Application Data
(60) Provisional application No. 61/370,693, filed on Aug. 4, 2010.

(51) Int. Cl. G01N 21/77; G01N 21/78

(52) U.S. Cl. 436/94; 436/164; 436/172; 422/82.05

(57) ABSTRACT

The present invention is in the field of household cleaning, for example laundry products and methods. The invention is directed to the use of indicator materials, such as fluorescent indicator materials, for detecting or visualizing organic laundry soils, particularly those that tend to be invisible to the naked eye, such as sebum, perspiration, biological soils, odor-causing soils/stains and tannins. In addition, the present invention is directed to methods of using indicator materials, such as fluorescent indicator materials, to detect such soils on fabrics, and to determine and demonstrate the cleaning efficacy of a laundry product.

### CROSS REFERENCE TO RELATED APPLICATIONS

The present application claims the benefit of U.S. Provisional Appl. No. 61/370,693, filed Aug. 4, 2010, which is incorporated herein by reference in its entirety.

### BACKGROUND OF THE INVENTION

1. Field of the Invention

The present invention is in the field of household cleaning, for example laundry products and methods. The invention is directed to the use of indicator materials, such as fluorescent indicator materials, for detecting or visualizing organic laundry soils, particularly those that tend to be invisible to the naked eye, such as sebum, perspiration, biological soils, odor-causing soils/stains and tannins. In addition, the present invention is directed to methods of using indicator materials, such as fluorescent indicator materials, to detect such soils on fabrics, and to determine and demonstrate the cleaning efficacy of a laundry product.

2. Related Art

The reduction or elimination of phosphate in detergents because of environmental concerns and the reduction of water temperatures in the washing machine for both energy conservation and cost savings have contributed to increased stain removal problems in laundering. These stain removal problems are reflected in the proliferation of products for pre-soaking or pre-treatment of stained laundry items prior to washing or to be added to the wash solution to help insure the complete removal of stains. Included among such products are presoaks and detergency boosters, prespotters, bleaches, and water softeners. In addition to these products, heavy-duty liquid detergents and pastes prepared from detergent powders are used to pretreat stains before laundering.

There are a number of frequently encountered soils that are often very difficult to remove from clothing and other fabrics. Such soils and stains include those caused by sebum, perspiration, and tannins. The challenge of removing such soils and stains from clothing has made it difficult to formulate laundry product compositions that are effective at removing such soils/stains while avoiding harm to the clothing or fabric.

Different stains often require different treatment methods, different laundry products, and different temperatures. Furthermore, due to the wide range of fabrics and fabric blends it is necessary to determine the best detergent for the type of fabric.

Oil and grease borne soils on laundry are typically caused by frying oil, grease, tomato or spaghetti sauce, perspiration (sebum), and non-saponifiable oil stains such as motor oil or petroleum oils. Removal of oily stains is usually done using very hot water wash conditions (typically 110-150° F.). This can be a problem if the fabric cannot be cleaned in hot water due to problems associated with the colorfastness or potential for shrinkage of the fabric. Additionally, the current trend is to save energy and use much lower washing temperatures such as those below 80° F. Unfortunately, oily soils are not easily removed at these lower temperatures.

Thus, there is a need to determine the cleaning efficacy of a laundry product. More specifically, there exists a need to determine the cleaning efficacy of a laundry product in cold water.

Unaided, visual inspection of fabric will usually not be able to detect “invisible” stains such as those from sebum, perspiration, certain invisible biological stains, and tannins. Therefore, simple visual inspection does not ensure that proper cleaning has occurred.

Soils caused by sebum, perspiration, and tannins often attract moths and other destructive pests. Therefore, one does not want to store a soiled item of clothing.

Additionally, drying and ironing a soil that has remained on fabric after washing may cause the stain to “set in.” Furthermore, the heat from drying or ironing the soiled fabric may cause an otherwise “invisible” stain to appear. For example, heat tends to make invisible tannins stains, such as those from white wine, turn yellow. Additionally, during the dry cleaning process, exposure of the invisible stain to heat will oxidize the sugar in the soil and will make the stain appear. Therefore, one does not want to dry, iron, or dry clean fabrics before complete removal of stains.

Thus, a need exists for a method of demonstrating to users the cleaning efficacy of one or more laundry products in a commercial setting. There also is a need to determine the cleaning efficacy of one or more laundry products in a home setting.

Furthermore, a need exists for a method of determining the presence of an invisible soil on a fabric.

Additionally, the development of laundry stain removal test methods is currently receiving attention. The need for such test methods is reflected in the proliferation of products for presoaking or pretreatment of stained laundry items prior to washing or for addition to the main wash solution to help insure complete removal of stains.

Thus, there is a need to develop a method of testing different laundry products on different fabrics in a laboratory setting quickly and efficiently. Furthermore, there is a need to compare the results of one laundry product on a given fabric with another laundry product on the same fabric blend. Also, there is a need to develop a standardized method for determining the cleaning efficacy of a laundry product that can be used in a laboratory setting.

It is to be understood that both the foregoing general description and the following detailed description are exemplary and explanatory only, and are not restrictive of the invention as claimed.

### BRIEF SUMMARY OF THE INVENTION

Accordingly, one aspect of the invention is to provide a method for visualizing invisible organic laundry soils such as sebum, perspiration, other biological soils (including urine, feces, blood, serum, saliva, semen and the like), and tannins. It is another aspect of the invention to provide a method for using a fluorescent indicator material to determine the cleaning efficacy of a laundry product.

In one embodiment, the present invention provides a method of determining the presence of a soiling substance on a fabric comprising:

(a) applying an indicator material to a fabric; and

(b) observing the fabric;

wherein a change in the color, fluorescence intensity and/or reflectance at a specific wavelength of the indicator material indicates the presence of a soiling substance.

In another embodiment, the present invention provides a method of determining the cleaning efficacy of a laundry product comprising:
(a) applying a soiling substance to a first fabric and a second fabric;
(b) cleaning the first fabric with a laundry product;
(c) applying an indicator material to the cleaned first fabric and the second fabric; and
(d) observing the first and second fabrics, and comparing the color, fluorescence intensity and/or percent reflectance at a specific wavelength of the first fabric from (c) to the color, fluorescence intensity and/or percent reflectance at a specific wavelength of the second fabric from (c) to determine the efficacy of the laundry product.

In another embodiment, the present invention provides a method of comparatively analyzing the cleaning efficacy of two laundry products comprising:
(a) applying a soiling substance to a first fabric and a second fabric;
(b) cleaning the first fabric with a first laundry product;
(c) cleaning the second fabric with a second laundry product;
(d) applying an indicator material to the cleaned first fabric;
(e) applying the indicator material used in (d) to the cleaned second fabric;
(f) observing the first and second fabrics, and comparing the color, fluorescence intensity and/or percent reflectance at a specific wavelength of the fabric from (d) to the color, fluorescence intensity and/or percent reflectance at a specific wavelength of the fabric from (e) to determine the cleaning efficacy of the laundry product.

In one embodiment of the present invention, the soiling substance on the fabric is selected from the group consisting of sebum, perspiration, a biological soil (e.g., urine, feces, blood, serum, saliva, semen, etc.), tannins, and mixtures thereof.

In another embodiment of the present invention, the soiling substance on the fabric is invisible to the naked eye.

In another embodiment of the present invention, the soiling substance has dried on the fabric.

In one embodiment of the present invention, the fabric is selected from the group consisting of polyester, cotton, nylon, silk, elastane, and blends thereof. In certain such embodiments, the fabric is a consumer-worn garment (such as clothing, undergarments, athletic apparel, overgarments, etc.) or an otherwise consumer-used fabric (such as a fabric tablecloth, towel, napkin, placemat, diaper, cloth wipe, dustcloth, etc.).

In one embodiment of the present invention, the fabric is cleaned with a laundry product prior to application of the indicator material.

In one embodiment of the present invention, the cleaning comprises washing in a washing machine (or an equivalent device, including but not limited to a tergetometer) or any other laboratory instrument or home device that is used to clean laundry or remove stains. In another embodiment, the cleaning comprises washing the fabric by hand.

In another embodiment of the present invention, the cleaning is at a temperature below 50° F. In another embodiment, the cleaning is at a temperature of from about 50° F. to about 80° F. In another embodiment, the cleaning is at a temperature of from about 80° F. to about 110° F.

In one embodiment of the present invention, the laundry product is a laundry detergent.

In one embodiment of the present invention, the indicator material is a fluorescent compound, such as a compound selected from the group consisting of 1-pyrenyldiazomethane, acetylacetone, diphenylhydrazine, luminarin 4, L-leucine-4-methyl-7-coumarinylamide, 9-anthryldiazomethane, napthyldiazomethane, 4-(2-carbazoylpyrrolidin-1-yl)-7-(N,N-dimethylaminosulfonyl)-2,1,3-benzoxadiazole, N-(bromoacetyl)-N′-[5-(dimethylamino)naphthalene-1-sulfonyl]piperazine, and combinations thereof, and others described in detail herein.

In one embodiment of the present invention, the indicator material is dissolved in a solvent prior to application.

In one embodiment of the present invention, the solvent that the indicator material is dissolved in is a non-aqueous solvent.

In additional embodiments of the invention, particularly when invisible tannins soils are to be detected, an alternative detection agent or indicator material may be used, including, for example, a reducing agent, or metallic salt such as ferrous sulphate. Such detection agents or indicator materials are preferably dissolved or suspended in colloid in aqueous solvents, such as water, buffered salt solutions, and the like.

In one embodiment of the present invention, the indicator material is applied to the fabric by spraying or others means of application including, but not limited to, brushing, dabbing, and the like. In one embodiment of the present invention, after application of the indicator material to the fabric, the fabric is allowed to remain under the presence of ultraviolet light for about 30 minutes before observing.

In one embodiment of the present invention, after application of the indicator material, the observing is performed with the naked eye. In another embodiment, the observing is performed with a camera. In certain embodiments when the observing is performed with the naked eye or with a camera, an excitation light source may be used to assist in the visualization/observing process. In another embodiment, the observing is using a spectrophotometric or colorimetric instrument, which may be or contain a fluorescent or ultraviolet light source such as a fluorescent or ultraviolet lamp. In another embodiment, the observing is visual inspection of the fabric irradiated using an ultraviolet light source such as a lamp, which in some embodiments may be hand-held.

In one embodiment of the present invention, the soiling substance is applied to the fabric prior to cleaning.

In one embodiment of the present invention, the soiling substance is dissolved in a solvent prior to application.

In one embodiment of the present invention, the ratio of soiling substance to solvent is from about 0.5% to about 5% soiling substance to about 99.5% to about 95% solvent.

In one embodiment of the present invention, the soiling substance is allowed to dry on said fabric for about 2 hours. In another embodiment, the soiling substance is allowed to dry on said fabric for about 2-24 hours (e.g., about 2, about 3, about 4, about 5, about 6, about 7, about 8, about 9, about 10, about 11, about 12, about 13, about 14, about 15, about 16, about 17, about 18, about 19, about 20, about 21, about 22, about 23 or about 24 hours). Once dried, stained or soiled fabrics used for testing can also be stored for extended periods of time, preferably vacuum-sealed and refrigerated at about 4°-10° C.

In one embodiment of the present invention, the first fabric and the second fabric are the same material. In another embodiment, the first and second fabrics are two different materials.

In one embodiment, the present invention provides a kit for determining the presence of a soiling substance (such as sebum, perspiration, other biological soils (including urine, feces, blood, serum, saliva, semen and the like), tannins and the like, and other soiling substances disclosed herein or that will be readily familiar to one of ordinary skill in the art) on a fabric comprising:

(a) an indicator material;

(b) a solvent for dissolving the indicator material; and

(c) an apparatus for applying the indicator material to a fabric.

In one embodiment of the present invention, the kit further comprises an ultraviolet lamp or light, which in certain embodiments may be a hand-held lamp or light.

In one embodiment, the present invention provides a kit for determining the cleaning efficacy of a laundry product comprising:

(a) a soiling substance;

(b) an indicator material; and

(c) an apparatus for applying the indicator material to a fabric.

In one embodiment of the present invention, the kit further comprises

(d) a solvent for dissolving the soiling substance; and

(e) a solvent for dissolving the indicator material.

Additional embodiments and advantages of the present invention will be set forth, in part, in the description that follows, will flow from the description, or may be learned by practice of the invention. The embodiments and advantages of the present invention will be realized and attained by means of the elements and combinations particularly pointed out in the appended claims.

### BRIEF DESCRIPTION OF THE DRAWINGS

FIG. 1 is a photograph of two different fabric swatches that were stained with synthetic body soil (synthetic sebum) and then washed with Sunlight® brand Deep Clean laundry detergent (FIGS. 1a and 1c) or that were unwashed (FIGS. 1b and 1d) and then sprayed with PDAM solution for detection of invisible stain according to the methods of the present invention. FIGS. 1a and 1b: visible light detection, demonstrating no visible stain or soil on either swatch. FIGS. 1c and 1d: UV light/fluorescence detection, demonstrating detectible soil/stain on the unwashed fabric (FIG. 1d), but little or no detectible soil/stain on the washed fabric (FIG. 1c).

### DETAILED DESCRIPTION OF THE INVENTION

The following description provides specific details, such as materials and dimensions, to provide a thorough understanding of the present invention. The skilled artisan, however, will appreciate that the present invention can be practiced without employing these specific details.

As used herein, the singular terms “a” and “the” are synonymous and used interchangeably with “one or more” and “at least one,” unless the language and/or context clearly indicates otherwise.

As used herein, the term “comprising” means including, made up of and composed of.

All numbers in this description indicating amounts, ratios of materials, physical properties of materials and/or use are to be understood as modified by the word “about,” except otherwise explicitly indicated.

The term “about” as used herein, includes the recited number ±10%. Thus, “about ten” means 9 to 11.

As used herein, the term “cleaning efficacy” refers to the ability of a laundry product to remove stains and soil. The cleaning efficacy can be measured either qualitatively or quantitatively.

As used herein, the term “invisible soil” is a soil that is not recognizable to the naked eye until after the fabric has been cleaned or until after an indicator material has been applied to the fabric.

As used herein, the term “soiling substance” is a liquid, solid, or semi-solid substance that has contacted the fabric and has caused a stain or a soil to remain on the fabric after the contact. The soil may be invisible or visible to the naked eye.

An indicator material is a substance that when applied to an organic substance, such as a soil, will cause the organic substance to become visible either to the naked eye or by using a spectrophotometric instrument which contains an ultraviolet light and which detects emitted fluorescence.

Fluorescence is the emission of light caused by the excitation of molecules with light of a specific wavelength. The emitted fluorescence is always observed at a wavelength longer than the incident excitation light (Stokes shift). Fluorescent compounds can be used to label and qualitatively and quantitatively analyze organic substances present in trace amounts. Analytically useful fluorescence is restricted to compounds possessing large conjugated systems in which the pi electrons can be promoted to an antibonding pi orbital. The electrons of a molecule can be excited to higher energy states, and the radiation that is absorbed in the process, or the energy emitted in the return to the ground state, is studied by the use of spectrophotometric methods. The set of frequencies absorbed by a sample determines its absorption spectrum; the frequencies emitted provide the emission spectrum. Aromatic hydrocarbons, such as 9-anthryldiazomethane, are a group of strongly fluorescent organic compounds since they are highly conjugated. Fluorescence is influenced by structural and environmental factors such as rigidity, solvent, pH, metal ions, and concentration.

In one embodiment, the method of the present invention is used in a laboratory setting to allow researchers to develop laundry products having the desired cleaning efficacy based on the soil type, fabric type, and/or water temperature. In one embodiment, the present invention provides a method of determining the cleaning efficacy of a laundry product comprising:
(a) applying a soiling substance to a first fabric and a second fabric;
(b) cleaning the first fabric with a laundry product;
(c) applying an indicator material to the cleaned first fabric and the second fabric; and
(d) observing the first and second fabrics, and comparing the color of the first fabric from (c) to the color of the second fabric from (c) to determine the efficacy of the laundry product.

In another embodiment, the method of the present invention is used in a commercial setting to show potential consumers the cleaning efficacy of one or more laundry products. The laundry product can be tested alone or can be compared to another laundry product. In one embodiment, the present invention provides a method of comparatively analyzing the cleaning efficacy of two or more laundry products comprising:
(a) applying a soiling substance to a first fabric and a second fabric;
(b) cleaning the first fabric with a first laundry product;
(c) cleaning the second fabric with a second laundry product;
(d) applying an indicator material to the cleaned first fabric;
(e) applying the indicator material used in (d) to the cleaned second fabric; and
(f) observing the first and second fabrics, and comparing the color of the fabric from (d) to the color of the fabric from (e) to determine the cleaning efficacy of the laundry product.

In another embodiment, the method of the present invention can be used in a home setting. In one embodiment, the present invention provides a method of determining the presence of a soiling substance on a fabric comprising:

(a) applying an indicator material to a fabric; and

(b) observing the fabric;

wherein a change in the color, fluorescent intensity and/or reflectance at a specific wavelength of the indicator material indicates the presence of a soiling substance.

In one embodiment, the soil to be visualized is a soil that is not easily visible to the naked eye. Alternatively, the soil to be visualized is a soil that is not visible on a colored fabric.

In one embodiment, the soiling substance has been deposited on the fabric (e.g., a garment or other consumer-used fabric, such as those described elsewhere herein) by an individual during normal usage. In another embodiment, the soiling substance is applied to the fabric.

In one embodiment the soil is a synthetic soil. In another embodiment the soil is a natural soil. Included among natural soils are bodily derived soils such as sebum and perspiration, as well as other biological soils such as urine, feces, blood, serum, saliva, semen and the like.

Tannins are phenolic compounds. Tannins stains can be from a variety of sources, including but not limited to alcoholic beverages (particularly wines), beer, berries, coffee, cologne, felt-tip water color pen or washable ink, fruit juice, soft drinks, tea, and tomato juice. In certain situations, tannins soils are rendered invisible by oxidation, particularly via exposure to air or to oxidizing compounds such as hypochlorite salts, peroxides, percarbonates and the like. Examples of invisible tannins soils include stains from white wine, clear sodas, tea, and clear juices. In one embodiment, the soiling substance is a white wine. In another embodiment, the soiling substance is a clear soda.

Sebum is the oily, waxy substance that is secreted by the sebaceous glands. Human sebum is composed of wax monoesters, triglycerides, free fatty acids, squalene, and other components such as cholesterol esters and cholesterol. Sebum is odorless, but its bacterial breakdown can produce odors. Soils from sebum can be from the human face and scalp and include hair oil, face oil, and earwax. In one embodiment, the soiling substance is dust sebum.

Perspiration is the production of a fluid consisting primarily of water as well as various dissolved solids that is excreted by the sweat glands in the skin of mammals. Perspiration also contains the organic substances 2-methylphenol, 4-methylphenol, urea, and lactate. Ordinary perspiration mostly contains water which evaporates and leaves a residue of various chemicals. In one embodiment, the soiling substance is perspiration.

Other bodily or biological soils may also be deposited onto a fabric in such a way or in such minute amounts that the soils are invisible or undetectable by the unaided eye. Examples of such additional bodily soils include, but are not limited to, urine, feces, blood, serum, saliva, semen and the like. Thus, in another embodiment of the invention, the soiling substance includes a bodily or biological soil.

The soil can be applied to the fabric in any amount that can be visualized. In one embodiment, the soiling substance is added directly to the fabric without solvent. In another embodiment, the soil is dissolved in a solvent prior to being applied to the fabric.

The soil can be dissolved in any solvent that is known to one of ordinary skill in the art. Examples of solvents for dissolving oils include hexane, heptane, toluene, petroleum ether, acetone, methyl acetate, ethyl acetate, petroleum ether, ethanol, acetonitrile, methanol, isopropanol, tetrahydrofuran, and ether. In one embodiment, the soil is dissolved in heptane. In another embodiment, the soil is dissolved in water.

The soil can be dissolved in a minimal amount of solvent or the solvent may be used to distribute a trace amount of the soil over a determined area of fabric. In one embodiment, the ratio of soiling substance to solvent is about 0.5:99.5, 1:99, 1.5:98.5, 2:98, 2.5:97.5, 3:97, 3.5:96.5, 4:96, 4.5:95.5, 5:95, 10:90, 20:80, 30:70, 40:60, 50:50, 1:99. In another embodiment the ratio of soiling substance to solvent is from about 0.5% to about 5% soiling substance to about 99.5% to about 95% soiling substance. In another embodiment the ratio of soiling substance to solvent is from about 1% to about 3% soiling substance to about 99% to about 97% soiling substance.

The soil can be applied to the fabric in any manner know to one of skill in the art. Examples of application methods include spraying, dipping, brushing, dropping, and swabbing. In one embodiment, the soil is brushed onto the fabric. In another embodiment, the soil is sprayed onto the fabric.

As one of ordinary skill will readily appreciate, soils are also deposited onto fabrics through the ordinary use or wearing of the fabrics by a person. Thus, the present compositions and methods are also suitable for use in detecting invisible soils such as those described herein that have been deposited onto fabrics, such as clothing, by the bodily secretions or excretions from a person wearing the clothing, or by other use of the fabrics by a person.

Fabrics with different chemical composition behave differently when stained and when treated with stain removal agents. For example, synthetic fibers such as acrylic, nylon, olefin, silk, polyester, and blends of these fibers or cottons with permanent press finishes are tough and durable but have a special attraction for oil stains. If oil stains are heat-set by the dryer or ironed into fabrics containing these fibers or finishes, removal can be difficult, if not impossible. One the other hand, if treated quickly these stains usually can be easily removed.

In one embodiment the fabric is a cotton-containing fabric. The cotton-containing fabric can be made of pure cotton or cotton blends including cotton woven fabrics, cotton knits, cotton denims, cotton yarns and the like. When cotton blends are employed, the amount of cotton in the fabric can be about 40, 50, 60, 70, 80, 90, or percent by weight cotton. When employed as blends, the companion material employed in the fabric can include one or more non-cotton fibers including other natural fibers such as wools, synthetic fibers such as polyamide fibers (for example, nylon, nylon 6, and nylon 66), acrylic fibers (for example, polyacrylonitrile fibers), and polyester fibers (for example, polyethylene terephthalate), polyvinyl alcohol fibers (for example, Vinylon), polyvinyl chloride fibers, polyvinylidene chloride fibers, polyurethane fibers (for example, spandex, lycra, and elastane), polyurea fibers and aramide fibers. In one embodiment, the fabric is 100% cotton. In another embodiment, the fabric is 85% polyester/15% cotton or 65% polyester/35% cotton.

In one embodiment, the fabric is a cellulose-containing fabric. Cellulose-containing fabric means any cotton or non-cotton containing cellulosic fabric or cotton or non-cotton containing cellulose blend including natural cellulosics and manmade cellulosics (such as Jute, flax, ramie, rayon, and the like). Included under the heading of manmade cellulose containing fabrics are regenerated fabrics that are well known in the art such as rayon. Other manmade cellulose containing fabrics include chemically modified cellulose fibers (e.g., cellulose derivatized by acetate) and solvent-spun cellulose fibers (e.g. lyocell).

In another embodiment, the fabric is a silk-containing fabric. A silk-containing fabric means any fabric containing silk fibers whether or not silk is the primary component of the fabric. Thus, included herein as examples of silk-containing fabrics are fabrics made of 100% silk, as well as silk blends in which the fabric contains silk as well as other fibers or fabric components such as those described herein and others that will be familiar to the ordinarily skilled artisan.

Visualization of soils may be even more difficult on a fabric that is lightly colored or is a dark color. In one embodiment the fabric is white. In another embodiment the fabric is a light-colored fabric.

In one embodiment, the fabric is pre-washed before application of a soiling substance. In another embodiment, the fabric is unwashed before application of a soiling substance.

In embodiments of the invention involving efficacy testing, soiling substances are applied to fabrics prior to testing different detergents or detergent components or formulations for their efficacy in removing the soils or soiling substances. The soiling substance can be applied to any area on the fabric, to a small portion of the fabric or to the entire area of the fabric. In one embodiment, the soiling substance is applied to the fabric in an area having about a 0.5. 1.0, 1.5, 2.0, 2.5, or 3.0 inch diameter. In certain such embodiments, the soiling substance is applied to the fabric in an area having from about a 0.5 to about a 2.0 inch diameter.

The amount of the soiling substance applied to the fabric can be any amount envisioned by one of skill in the art. In one embodiment, the amount of soiling substance applied to the fabric is about 1, 5, 10, 100, 200, 300, 400, 500, 600, 700, 800, 900, or 1000 microliters. In one embodiment, 500 microliters of soiling substance is applied to a 2 inch diameter of fabric. For soils deposited onto fabrics via ordinary use or wearing of the fabric by a person, the amount of soiling substance contained on the fabric is any amount that is naturally produced (i.e., excreted or secreted) by a person while wearing the fabric, or that is naturally deposited onto the fabric via use of the fabric by a person. Such soil amounts typically fall within the ranges described herein. Thus, in certain embodiments the fabric is worn or used by a consumer for a period of time prior to being tested in accordance with the present invention. The amount of soiling imparted by a consumer can vary based on usage, body placement, or physical/biological variations.

In one embodiment, the fabric is cleaned before the soiling substance has dried on the fabric. The soiling substance can be allowed to dry on the fabric before cleaning. In one embodiment, the soiling substance is allowed to dry on the fabric for about 30 minutes prior to cleaning. In additional embodiments, the soiling substance is allowed to dry on the fabric for about 1 hour, about 2 hours, about 3 hours, about 4 hours, about 5 hours, about 6 hours, about 7 hours, about 8 hours, about 9 hours, about 10 hours, about 11 hours, about 12 hours, or about 24 hours prior to cleaning the fabric. In another embodiment, the soiling substance is allowed to dry on the fabric from about 30 minutes to about 24 hours prior to cleaning the fabric. In a further embodiment, the soiling substance is allowed to dry on the fabric for a week prior to cleaning the fabric.

The soiling substance can be allowed to dry on the fabric at room temperature. Alternatively, the drying of the soiling substance on the fabric can be aided by blowing air on the fabric, allowing the fabric to dry in the sun, or by drying the fabric using heat.

The soiled fabric can be washed using any method known in the art for washing fabrics. In one embodiment, the soiled fabric is washed by hand. In another embodiment, the soiled fabric is washed using a machine.

The soiled article can be washed a single time or may undergo multiple washings. In one embodiment, the soiled fabric is washed once before an indicator material is applied.

The fabric may be washed using cold water temperatures, warm water temperatures, or hot water temperatures. In one embodiment, the fabric is washed at a temperature of about 50, 60, 70, 80, 90, 100, 110, 120, or 130° F. In another embodiment, the soiled fabric is washed at a temperature below about 50° F. In another embodiment, the soiled fabric is washed at a temperature of from about 50° F. to about 80° F. In another embodiment, the soiled fabric is washed at a temperature of from about 80° F. to about 110° F. In another embodiment, the soiled fabric is washed at a temperature of about 90° F.

There are a variety of known laundry products that can be used to pretreat or treat a soil. Laundry products include laundry detergents, including general purpose, light duty, and combination laundry detergents, which can be in powder or liquid form. Laundry products also include laundry bleaches which can be oxygen bleach, sodium hypochlorite bleach, carbonate-based bleach, fluorescent dyes and color removers. Laundry products also include powder and liquid detergent boosters, enzyme presoaks, and prewash soil and stain removers. Laundry products used for the pre-treatment of a soil are typically applied to a limited area of a soiled fabric prior to bulk washing of the fabric. In one embodiment, the laundry product is a liquid laundry detergent.

The indicator material has the ability to fluorescence or phosphoresce When attached to an organic substance and subjected to ultraviolet light. Alternatively, the indicator material can undergo an oxidation or reduction reaction when it contacts an organic substance.

Indicator materials that can be used in the compositions and methods of the present invention include any indicators know to one of ordinary skill in the art. Major classes of ultraviolet and fluorescent derivitization reagents for carboxylic acids and fatty acids include coumarin analogues, alkyl halides, diazoalkanes, and amines.

The following indicator materials can be used either alone or in combination as the indicator materials: 1-pyrenyldiazomethane, acetylacetone, diphenylhydrazine, luminarin 4, L-leucine-4-methyl-7-coumarinylamide, 9-anthryldiazomethane, napthyldiazomethane, 4-(2-carbazoylpyrroldin-1-yl)-7-(N N-dimethylaminosulfonyl)-2,1,3-benzoxadiazole, and N-(bromoacetyl)-N-[5-(dimethylamino)naphthalene-1-sulfonyl]piperazine, 2-nitrophenylhydrazine, 6,7-dimethoxy-1-methyl-2(1H)-quinoxaline-3-propionyl carboxylic acid hydrazide, p-(4,5-diphenyl-1H-imidazol-2-yl)-benzohydrazide, p-(1-methyl-1H-phenanthro-[9,10-d]imidazol-2-yl)-benzohydrazide, p-(5,6-dimethoxy-2-benzothiazoyl)-benzohydrazide, 1-(2-naphthyl)diazomethane, 4-diazomethyl-7-methoxycoumarin, 4-bromomethyl-7-methoxycoumarin, 4-bromomethyl-7-acetoxycoumarin, 3-bromomethyl-6,7-dimethoxy-1-methyl-2(1H)-quinoxalinone, 9-bromomethylacridine, 4-bromomethyl-6,7-methylenedioxycoumarin, N-(9-acridinyl)-bromoacetamide, 2-(2,3-naphthylimino)ethyltrifluoromethane sulfonate, 2-(phthalmino)ethyltrifluoromethane sulfonate, N-chloromethylphthalic imide, chloromethyl-4-nitrophthalic imide, N-chloromethylisatin, o-(p-nitrobenzyl)-N,N′-diisopropylurea, monodansylcadaverine, 2-(p-aminomethylphenyl)-N,N-dimethyl-2H-benzotriazole-5-amine, 4-(2-phthalimidyl)benzoyl chloride, p-nitrobenzyl bromide, phenacyl bromide, p-chlorophenacyl bromide, p-iodinephenacyl bromide, p-nitrophenacyl bromide, p-phenylphenacyl bromide, p-phenylazophenacyl bromide, and N,N-dimethyl-p-aminobenzeneazophenacyl chloride. In one embodiment, the indicator material is 1-pyrenyldiazomethane. In another embodiment, the indicator material is anthryldiazomethane. In another embodiment, the indicator material is N-(bromoacetyl)-N′-[5-(dimethylamino)naphthalene-1-sulfonyl]piperazine.

In embodiments of the invention suitable for detecting carboxylic acid-containing stains, the following classes and types of indicator materials are useful: amines, such as L-leucine-(4-methyl-7-coumarinylamide) and S-(−)-α-methylbenzylamine; hydrazines, such as 5,6-dimethoxy-2-(4-hydrazinocarbonylphenyl)benzothiazole, 4-(5,6-dimethoxy-2-benzylmidazoyl)benzohydrazide and DMEQ-hydrazide; alcohols, such as 9-anthracenemethanol and dansyl ethanolamine; and activated halides, such as 3-bromomethyl-7-methoxy-1,4-benzoxazin-2-one, 4-(bromomethyl)-6,7-dimethoxy-coumarin and 2-bromoacetyl-6-methoxynaphthalene.

In embodiments of the invention suitable for detecting aldehyde-containing stains, the following classes and types of indicator materials are useful: amines, such as 8-Aminonaphthalene-1,3,6-trisulfonic acid, 2-aminopyridine and 9-aminopyrene-1,4,6-trisulfonic acid; aminophenols, such as 2-amino-4,5-ethylenedioxyphenol; aminothiols, such as 2,2′-dithobis(1-amino-4,5-dimethoxybenzene; diamines, such as 1,2-diamino-4,5-ethylenedioxybenzene and dimethyl-1,2-phenylenediamine; diketones, such as acetylacetone (which is rendered visible with white light), 1,3-cyclohexanedione and 5,5-dimethyl-1,3-cyclohexanedione; enones, such as 3-methyl-1-phenylpyrazolin-5-one; and hydrazines, such as dansyl hydrazine.

In embodiments of the invention suitable for detecting thiol-containing stains, the following classes and types of indicator materials are useful: activated halides, such as 4-(aminosulfonyl)-7-fluoro-2,1,3-benzoxadiazole, 1-benzyl-chloropyridinium bromide and 7-chloro-2,1,3-benzoxadiazole-4-sulfonic acid (ammonium salt); acyl halides, such as 4-(N-chloroformylmethyl-N-methyl)amino-7-N,N-dimethylaminosulfonyl-2,1,3-benzoxadiazole; aziridines, such as dansyl aziridine; chloramines, such as N-chlorodansylamide; dialdehydes, such as phthalaldehyde; disulfides, such as N-[6-(7-amino-4-methylcoumarin-3-acetamido)hexyl)]-3′-(2′-pyridyldithio)propionamide and 5,5′-dithiobis(2-nitrobenzoic acid); enones, such as methyl acrylate, methyl 4-(6-methoxynaphthalen-2-yl)-4-oxo-2-butenoate and 4-(6-methylnaphthalen-2-yl)-4-oxo-2-butenoic acid; isothiocyanates, such as R-(−)-4-(3-isothioxcyanatopyrrolidin-1-yl)-7-nitro-2,1,3-benzoxadiazole; maleimides, such as N-(4-anilinophenyl)maleimide, 7-diethylamino-3-(4′maleimidylphenyl)-4-methyl coumarin, N-[4-(6-dimethylamino-2-benzofuranyl)phenyl]maleimide and N-(1-pyrenyl)maleimide; and quinines, such as 3,5-di-tert-butyl-1,2-benzoquinone.

In embodiments of the invention suitable for detecting amine-containing stains, the classes and types of indicator materials specified hereinabove are useful, as are the following additional classes and types of indicator materials: aldehydes, such as 5-(4-pyridyl)-2-thiophenecarbaldehyde and salicylaldehyde; and alkenes, such as 1-phenylsulfonyl-3,3,3-trifluoropropene, N-methylisatoic anhydride and pentafluoropropianoic anhydride.

Other indicator materials, and classes and types thereof, suitable for use in the compositions and methods of the present invention will be familiar to those of ordinary skill in the relevant arts.

The indicator materials used in the compositions and methods of the present invention are typically applied in the form of a solution. The solutions can be obtained by first preparing a stock solution by dissolving a small amount of dye in a suitable solvent. Dependent upon the properties of the indicator material, the solvent may be aqueous or non-aqueous. If the indicator material is subject to degradation in water, a non-aqueous solvent can be used. Suitable solvents for the indicator materials of the invention include hexane, heptane, toluene, petroleum ether, acetone, methyl acetate, ethyl acetate, petroleum ether, ethanol, acetonitrile, methanol, isopropanol, tetrahydrofuran, and ether. The indicator material can be in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100% of the volume of the stock solution. In one embodiment, the indicator material is dissolved in ethyl acetate. In another embodiment, the indicator material is dissolved in non-aqueous ethyl acetate.

The indicator material may be applied to the soiled fabric using any methods commonly used by one of ordinary skill in the art. Examples of application methods include spraying, dipping, brushing, dropping, dabbing and swabbing. In one embodiment, the indicator material is brushed onto the fabric. In another embodiment, the indicator material is sprayed onto the fabric.

The indicator material can be allowed to remain on the fabric for a period of time before observation or it may be observed immediately. In one embodiment the indicator material remains on the fabric for about 10 minutes, about 20 minutes, about 30 minutes, about 1 hour, about 2 hours, about 3 hours, about 4 hours, about 5 hours, about 6 hours, about 7 hours, about 8 hours, about 9 hours, about 10 hours, about 11 hours, about 12 hours, or about 24 hours prior to observing the fabric.

The fabric on which the indicator material has been applied can be placed in the dark, placed under ambient light, or placed under ultraviolet light. In one embodiment, the fabric on which the indicator material has been applied is placed under ultraviolet light for about 10 minutes, about 20 minutes, about 30 minutes, about 1 hour, about 2 hours, about 3 hours, about 4 hours, about 5 hours, about 6 hours, about 7 hours, about 8 hours, about 9 hours, about 10 hours, about 11 hours, about 12 hours, or about 24 hours prior to observing the fabric. In another embodiment, the fabric on which the indicator material has been applied is place under ultraviolet light for about 10 minutes, about 20 minutes, about 30 minutes, about 1 hour, about 2 hours, about 3 hours, about 4 hours, about 5 hours, about 6 hours, about 7 hours, about 8 hours, about 9 hours, about 10 hours, about 11 hours, about 12 hours, or about 24 hours prior to observing the fabric.

The fabric on which the indicator material has been applied can be allowed to sit at room temperature or may be subjected to heating using traditional methods. In one embodiment, the fabric on which the indicator material has been applied is allowed to sit in the sun.

In one embodiment, once the fabric is coated with the indicator material, it is placed under an ultraviolet light. The ultraviolet light is turned on. If there is organic material on the fabric, it will fluoresce and appear to the viewer, although the organic material would not normally be seen under normal light. In one embodiment, the color and/or wavelength change is not perceptible to the naked eye and is only is perceptible when the fabric is exposed to ultraviolet light. In another embodiment, the color and/or wavelength change is perceptible to the naked eye and when the fabric is exposed to ultraviolet light. In certain such embodiments, the color and/or wavelength change visible to the naked eye when the fabric is exposed to ultraviolet light can be qualitatively examined, for example by photography of the fabric upon exposure to ultraviolet light; comparisons can then be made between fabrics or fabric swatches regarding the difference in fluorescence intensity (brightness) or wavelength (color) either quantitatively (e.g., using digital photographic analysis) or qualitatively (e.g., by scoring intensity or wavelength by visual observation), according to observation and analysis methods that will be familiar to the ordinarily skilled artisan.

In another embodiment, the color and/or wavelength change is measured using a spectrophotometric instrument. The spectrophotometer used is not limited as far as the instrument can measure the degree of exhibited color and/or wavelength of the fabric. Examples of suitable such apparatuses are known to one of skill in the art. In one embodiment, the apparatus or instrument is an ultraviolet-visible (UV/Vis) spectrophotometer. The UV/Vis spectrophotometer can measure wavelengths throughout the ultraviolet, visible, and near infrared regions. In other embodiments, the apparatus or instrument is a colorimeter or a fluorescence spectrophotometer. In another embodiment, the spectrophotometric instrument is a visible spectrometer. In additional embodiments, the apparatus or instrument is or contains an ultraviolet light, which may in certain such embodiments be a hand-held ultraviolet light.

Ultraviolet light has a wavelength in the range of 10 nm to 420 nm. A bulb with a UV emission spectrum of a typical mercury tube light extends from about 345 nm to about 400 nm with a well-defined peak at about 366 nm. A typical hand-held ultraviolet light will produce light at one or more wavelengths. In one embodiment, the ultraviolet light has a wavelength of between about 254 nm and about 365 nm. In certain preferred embodiments, such as those using 1-pyrenyldiazomethane or anthryldiazomethane as the indicator material, detection is accomplished using a fluorescence excitation wavelength of about 300 nm to about 350 nm, and more particularly about 340 nm, and a fluorescence emission wavelength of about 350 nm to about 425 nm, and more particularly about 400 nm.

In one embodiment, the color, fluorescence intensity and/or percent reflectance at a specific wavelength is measured qualitatively and the color, fluorescence and/or percent reflectance at a specific wavelength observed is compared to the color, fluorescence intensity and/or percent reflectance at a specific wavelength observed using a standard laundry product. In another embodiment, the color, fluorescence intensity and/or percent reflectance at a specific wavelength is measured qualitatively and the color, fluorescence intensity and/or percent reflectance at a specific wavelength observed is compared to the color, fluorescence intensity and/or percent reflectance at a specific wavelength observed using a different laundry product.

In one embodiment, the color, fluorescence intensity and/or percent reflectance at a specific wavelength is measured quantitatively and the color, fluorescence intensity and/or percent reflectance at a specific wavelength observed is compared to the color, fluorescence intensity and/or percent reflectance at a specific wavelength observed using a standard laundry product. In another embodiment, the color, fluorescence intensity and/or percent reflectance at a specific wavelength is measured quantitatively and the color, fluorescence intensity and/or percent reflectance at a specific wavelength observed is compared to the color, fluorescence intensity and/or percent reflectance at a specific wavelength observed using a different laundry product. Exemplary methods for performing such detection are described in the Examples herein, and will be well-known to those of ordinary skill in the art.

In one embodiment, the fabric is cleaned after the indicator material has been applied to the fabric.

In one embodiment, the present invention provides a kit for use in a laboratory setting to allow researchers to develop laundry products. In one embodiment, the present invention provides a kit for determining the presence of a soiling substance on a fabric comprising:

(a) an indicator material;

(b) a solvent for dissolving the indicator material; and

(c) an apparatus for applying the indicator material to a fabric.

In another embodiment, the present invention provides a kit for determining the cleaning efficacy of a laundry product comprising:

(a) a soiling substance;

(b) an indicator material; and

(c) an apparatus for applying the indicator material to a fabric.

In another embodiment, the kit of the present invention can further comprise a soiling substance, a fabric, a solvent for dissolving the soiling substance, a solvent for dissolving the indicator material, and/or an ultraviolet light source which may, in some embodiments, be a hand-held ultraviolet light or lamp.

The following example is illustrative, but not limiting, of the various aspects and features of the present invention.

### EXAMPLES

### Example 1

Two laundry detergent formulations, detergent A and detergent B, are tested for their efficacy in removing sebum stains. Fabric is cut into test pieces of a specified size and these are then soiled by applying a sebum emulsion using a brush. The soil is painted onto two pieces of fabric inside a 2″ diameter circle and allowed to air dry overnight prior to laundering using typical conditions. Typical cleaning conditions include using a washing machine with a water temperature of 90° F. The first piece of fabric is added to the washing machine with laundry detergent A. After cleaning the fabric, an indicator material dissolved in heptane is sprayed onto the fabric. The indicator material (1-pyrenyldiazomethane, 250 ppm in solution; “PDAM solution”) is allowed to dry on the fabric under ultraviolet light for 30 minutes. The fabric is then placed under an ultraviolet light spectrophotometer to measure the UV activity, or is evaluated for fluorescence intensity by measuring the intensity of fluorescence emitted at about 400 nm, using an excitation wavelength of about 340 nm. In such methods, the higher the UV activity or fluorescence intensity observed, the higher the level of soil contained on the observed area of the fabric.

Using the same cleaning conditions, the second piece of fabric and laundry detergent B are added to the washing machine. After cleaning the fabric, PDAM solution is sprayed onto the fabric. The indicator material is allowed to dry on the fabric under ultraviolet light for 30 minutes. The fabric is then placed under an ultraviolet light spectrophotometer to measure the UV activity.

To compare effectiveness of the two laundry detergents at removing sebum stains from fabric, the UV activity of the fabric washed using laundry detergent A is compared to the UV activity of the fabric washed using laundry detergent B, visualizing the light emission in the stained areas. Using this methodology, a higher level of light emission indicates a higher amount of stain remaining (or present) on that area of the fabric. Detergent effectiveness is then compared between detergents A and B by comparing the level of staining remaining (or present) on the fabric; for example, a lower amount of light emission on the fabric laundered in detergent A as compared to that on the fabric laundered in detergent B indicates that detergent A is more effective at removing that particular stain or stain type than in detergent B.

The same approaches are followed for other stain types, including those described elsewhere herein and others that are known in the art and that will be familiar to those of ordinary skill. Taking the approach described herein, the effectiveness of different laundry detergent formulations against a variety of stain types, particularly otherwise invisible stain types, can be readily determined. In addition, the approaches described herein allow the ordinarily skilled artisan to optimize detergent formulation, by examining the impact upon detergency efficacy of addition to, or removal from, the formulation of one or more specific components (e.g., surfactants, polymers, enzymes, etc.) for a given stain or panel of stains.

### Example 2

An exemplary protocol to carry out the process described in Example 1 is as follows:

I. Objective: Identifying the presence, or the lack of, of invisible body oils (synthetic or real), odors, or other potential residues that may be present on a fabric, by interaction of the invisible body oils, odors or other residues with a fluorescence chemical.

II. Materials:

1. 1-pyrenyldiazomethane (Pdam), purchased from Invitrogen (Carlsbad, Calif.); 25 mg samples.

Ethyl Acetate;

250 ml Beaker;

100 ml amber Erlenmeyer flask;

Analytical aspirator;

Synthetic Sebum, purchased from Scientific Services S/D, Inc. (Sparrow Bush, NY), or consumer-worn or consumer-used fabrics (e.g., garments, sheets, pillow cases);

Heptane (if using synthetic sebum);

Laboratory hood, lab coat, gloves, safety glasses and UV protective glasses;

UV lamps (short wave and/or long wave);

Thick round art brushes;

Fabric swatches for controls (if desired);

Deep Freezer (<−30° C.);

Tin/aluminum foil;

Cardboard backing (2-3 ft square);

Compressed air and air tubing.

III. Safety: The chemicals used in this process can be dangerous to your health. Please use proper safety precautions including use of laboratory hoods.

IV. Procedure.

Using a Synthetic Sebum Solution:

Using synthetic sebum purchased from Scientific Services, mix your desired percent inclusion level with Heptane. Inclusion levels may range from 0.5%-5%. Specific projects may use levels outside this range. 0.5%-1% works well at seeing complete removal for top clean products in comparison to incomplete removal for less efficient products.

Mix Heptane and Synthetic Sebum on a stir plate until complete dissolution. This sample can be refrigerated for future use. Allow to warm to room temperature before usage.

Polyester fabric (720H—Testfabrics) is an optimal fabric for product differentiation. Other fabrics can be used as well.

Apply 500 microliters of sebum solution via a round art brush to fabrics in a 2 inch diameter area. 500 microliters is a suggestion, other amounts can be used depending on desired stain size and dilution. Fabrics should be suspended either using internal wooden racks or over a beaker using a rubber band to secure the fabric.

Make as many stains as required by your experimental design. At least 5 per product is advised to give some statistical relevance.

Allow the stains to dry overnight.

Wash the stains in your desired detergent products per your internal washing protocol.

Dry stains on a dryer rack or static dryer.

Using Real Garments or Pillowcases/Sheets:

Ascertain real garments, pillowcases, sheets, etc. from consumers.

Articles should be cut in half. One half should be left unwashed to illustrate the level of presence of body oil or odor. The other half should be washed in its respective product according to internal washing protocols.

Due to the presence of dyes in detergents, you may want to pre-wash articles before having consumers wear or use them. This will optimize the side by side comparison without.

Pdam Solution Preparation and Application:

Purchase Pdam (1-pyrenyldiazimethane) from Invitrogen. Samples should be stored in a deep freezer until ready for preparation.

Using an amber Erlenmeyer flask, combine 25 mg of Pdam with 100 ml of Ethyl Acetate. Note: Ethyl Acetate can hydrate and become less effective or even non effective. Ensure that the cap is always on tight.

Mix the Pdam and ethyl acetate solution by hand or stir bar for a few minutes. Solutions can be stored in a deep freezer if you are planning on using at a later date. Wrap flask and stopper with parafilm.

Pour the Pdam solution into an aspirator wrapped in foil.

Mount fabrics, garments, pillowcases, or sheets on a cardboard backing using thumb tacks or clips in a laboratory hood.

Attach the aspirator to the compressed air nozzle via an air tube.

Slowly turn the air on and apply the pdam in a fashion that uniformly covers your desired area. Do not over saturate an area. Apply an even coat.

Repeat for all swatches or materials.

Remove swatches from the hood and allow to dry in the presence of UV light. Use either a window (i.e., sunlight) or UV light room. UV will initiate the reaction of the Pdam and the soil/odor.

Allow the fabrics to completely dry. This may take 30 or so minutes.

Observation of Fluorescence:

Using a handheld UV lamp, illuminate the stained area to excite and expose the potential fluorescence. Short wave UV lamps tend to be optimal for illustrating the presence of the fluorescence. Long wave can be substituted if short wave is not accessible. Note: Always wear UV protective safety glasses when using short wave UV lamps.

Images of the fluorescence can be taken with a camera. Do not use a flash. Using a tripod will be required due to the long exposure time to minimize blurriness.

Fluorescence will only last a day or two on the fabric before significant reduction.

Instrumental Assessment:

The usage of a spectrophotometer can be one method to quantify the fluorescence. Assess with the inclusion of UV light within the spectrophotometer. CIE b* can be one way to look at the color impact of the fluorescence.

Specific wavelengths can be looked at to observe the magnitude of fluorescence differences. Observe emission wavelengths of 450 nm-550 nm (using excitation wavelengths of about 340 nm) to pinpoint the maximum fluorescence intensity or reflectance caused by the Pdam fluorescence. Fluorometers can also be used to excite the Pdam and capture its emission wavelength.

### Example 3

Using the testing protocols described in Examples 1 and 2 above, three commercially available laundry detergent formulations were tested in laundry test protocols to determine their efficacy in removing certain invisible soils/stains, using the detection methods of the present invention. The goal of these studies was to examine the comparative effectiveness of the various formulations on the test stains.

Testing was performed according to the following guidelines:

Multiple stain replicates (3-5) per product were conducted on each fabric swatch (fabric was a standard cotton/polyester blend);

Fabric swatches were stained with approximately 500 microliters of synthetic sebum, and dried for about 24 hours at room temperature;

Multiple wash replicates (minimum 2 in different machines);

Wash Conditions: Top loader mandatory, front loader optional; Water hardness (150 ppm); Wash Temperatures—Warm and Cold (90° F. and 59° F.+/−0.5 degrees wash cycles as measured in the drum prior to addition of fabrics; ambient rinse temperature); Fill level—Medium Load—18 gallons (Front loader=normal cycle); Wash cycle time (12 minutes for top loader; Front loader=normal cycle); Mixed ballast load (5.5 lbs ballast+stain sets=6 lbs total);

Drying: dried in standard commercially available dryers;

Fabrics were sprayed with PDAM indicator solution and processed for fluorescence or UV detection as described in Example 1;

Data analysis was performed utilizing SRI as defined in ASTM D-4265, UV excluded, specular included;

SRI readings recorded within 24 hrs of wash for stains sensitive to oxidation. Stains were protected from light, temperature and air between wash and reading. (refrigerated (4° C.); sealed (vacuum, zip-lock); in the dark);

Statistical analysis was performed utilizing SRI data at the 95% confidence limit.

Results

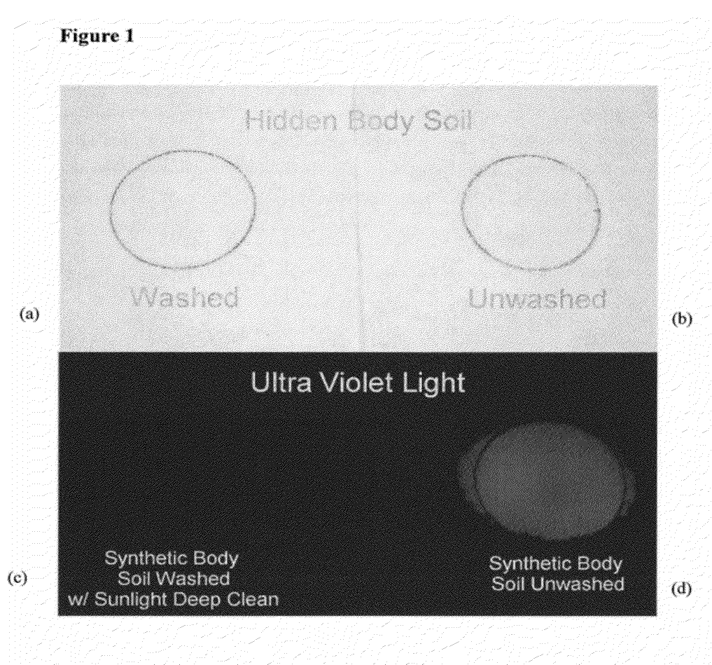

Qualitative results of testing are depicted in FIG. 1. As seen in FIGS. 1a and 1b, a fabric swatch stained with sebum and washed using a commercially available laundry detergent (FIG. 1a) appears to be as clean (i.e., devoid of stain) as a stained but unstained fabric swatch (FIG. 1b) using visible light observation; at this level of soil, sebum stains are not visible in white light, and are considered examples of “invisible soils.” However, using the methods of the present invention, the PDAM indicator solution sprayed onto these swatches shows that a fabric swatch washed in a commercially available laundry detergent formulation (Sunlight® brand Deep Clean laundry detergent; The Sun Products Corporation, Wilton, Conn.) has little or no residual soil present (FIG. 1c) when compared to the unwashed swatch (FIG. 1d). These results demonstrate that soils that are invisible in white light are nonetheless detectable using the methods of the present invention. Hence, fabrics that might qualitatively look “clean” under white light may, in fact, retain significant amounts of residual soil which can be detected using the methods of the present invention, thereby allowing the user (e.g., a consumer) to determine whether or not a given laundry detergent formulation or cleaning method is actually removing all of the soils from a given fabric.

These results were confirmed in quantitative testing, in which three commercially available laundry detergent formulations were tested against each other. Note: all test results shown are for testing performed at a wash temperature of 90° F. Results below are presented as least square mean differences (tukey HSD; α=0.050 Q=2.59747) between control (washed unstained swatch) and test (washed stained swatch) based on SRI readings, with a lower LSM indicating a lower difference and therefore better removal of the invisible stain by the formula tested. Formulas #1, #2 and #3 are different commercially available formulas.

Test #1:

| Formula | Level | Least Sq Mean |
|---|---|---|
| #1 | A | 16.670000 |
| #2 | B | 12.790417 |
| #3 | C | 10.802083 |

Levels not connected by same letter are significantly different.

Test #2:

| Formula | Level | Least Sq Mean |
|---|---|---|
| #1 | A | 16.735000 |
| #2 | B | 13.059167 |
| #3 | C | 11.201667 |

Levels not connected by same letter are significantly different.

These results show that commercial laundry detergent formula #3 was significantly better at removing invisible soil from the fabric swatches, compared to commercial formulas #1 and #2. Thus, the results of this comparative testing demonstrate that the methods of the present invention are capable of distinguishing the ability of different laundry detergent formulations to remove invisible soils, such as sebum, which are very difficult or impossible to distinguish using visible light detection using the unaided eye. Similar results have been obtained using fabric garments in which bodily soils such as sebum and perspiration were naturally deposited onto the fabric by ordinary wearing of the garment by a person.

Having thus described in detail the preferred embodiments of the present invention, it is to be understood by those of ordinary skill in the art that the same can be performed within a wide and equivalent range of conditions, formulation and other parameters without affecting the scope of the invention or any embodiments thereof. All patents, patent applications and publications cited herein are fully incorporated by reference in their entireties.

What is claimed is:

1. A method of determining the presence of a soiling substance on a fabric comprising:
(a) applying an indicator material to a fabric; and
(b) observing the fabric;
wherein a change in the color, fluorescence and/or percent reflectance at a specific wavelength of the indicator material indicates the presence of a soiling substance.

2. The method of claim 1, wherein the soiling substance is selected from the group consisting of sebum, perspiration, a biological soil, tannins, and mixtures thereof.

3. The method of claim 1, wherein the soiling substance on the fabric is invisible to the naked eye.

4. The method of claim 1, wherein the soiling substance has dried on the fabric.

5. The method of claim 1, wherein the fabric is selected from the group consisting of polyester, cotton, nylon, silk, elastane, and blends thereof.

6. The method of claim 1, wherein the fabric is a consumer-worn garment or a consumer-used fabric.

7. The method of claim 1, wherein the fabric is cleaned with a laundry product prior to application of the indicator material.

8. The method of claim 7, wherein said cleaning comprises washing in a washing machine.

9. The method of claim 7, wherein said cleaning is at a temperature below 50° F.

10. The method of claim 7, wherein the cleaning is at a temperature from about 50° F. to about 80° F.

11. The method of claim 7, wherein said cleaning is at a temperature from about 80° F. to about 110° F.

12. The method of claim 7, wherein the laundry product is a laundry detergent.

13. The method of claim 1, wherein the indicator material is selected from the group consisting of 1-pyrenyldiazomethane, acetylacetone, diphenylhydrazine, laminarin 4, L-leucine-4-methyl-7-coumarinylamide, 9-anthryldiazomethane, napthyldiazomethane, 4-(2-carbazoylpyrrolidin-1-yl)-7-(N,N-dimethylaminosulfonyl)-2,1,3-benzoxadiazole, N-(bromoacetyl)-N′-[5-(dimethylamino)naphthalene-1-sulfonyl]piperazine, and combinations thereof.

14. The method of claim 1, wherein the indicator material is dissolved in a solvent prior to application.

15. The method of claim 14, wherein the solvent is a non-aqueous solvent.

16. The method of claim 1, wherein the indicator material is applied to the fabric by spraying.

17. The method of claim 1, wherein the fabric is allowed to remain under ultraviolet light for about 30 minutes before observing.

18. The method of claim 1, wherein the fabric is allowed to remain under ultraviolet light for about 1 hour before observing.

19. The method of claim 1, wherein the observing is with the naked eye or with a camera.

20. The method of claim 1, wherein the observing is using a spectrophotometric instrument.

21. The method of claim 20, wherein the spectrophotometric instrument is or contains an ultraviolet light source.

22. The method of claim 7, wherein a soiling substance is applied to the fabric prior to cleaning.

23. The method of claim 22, wherein the soiling substance is dissolved in a solvent prior to application.

24. The method of claim 23, wherein the ratio of soiling substance to solvent is from about 0.5% to about 5% soiling substance to about 99.5% to about 95% solvent.

25. The method of claim 22, wherein the soiling substance is allowed to dry on said fabric for about 2 hours.

26. The method of claim 22, wherein the soiling substance is allowed to dry on said fabric for about 24 hours.

27. A method of determining the cleaning efficacy of a laundry product comprising:
(a) applying a soiling substance to a first fabric and a second fabric, wherein the second fabric is used as a control;
(b) cleaning the first fabric with a laundry product;
(c) applying an indicator material to the cleaned first fabric and the second fabric; and
(d) observing said first and second fabrics, and comparing the color and/or wavelength of the first fabric from (c) to the color and/or wavelength of the second fabric from (c) to determine the efficacy of the laundry product.

28. The method of claim 27, wherein the soiling substance is selected from the group consisting of sebum, perspiration, tannins, a biological soil, and mixtures thereof.

29. The method of claim 27, wherein the first and second fabric are selected from the group consisting of polyester, cotton, nylon, silk, elastane, and blends thereof.

30. The method of claim 27, wherein the first or second fabric is a consumer-worn garment or a consumer-used fabric.

31. The method of claim 27, wherein the first fabric and the second fabric are the same material.

32. The method of claim 27, wherein the soiling substance on the fabric is invisible to the naked eye.

33. The method of claim 27, wherein the soiling substance has dried on the fabric.

34. The method of claim 27, wherein said cleaning comprises washing in a washing machine or an equivalent device.

35. The method of claim 27, wherein said cleaning is at a temperature below 50° F.

36. The method of claim 27, wherein said cleaning is at a temperature from about 50° F. to about 80° F.

37. The method of claim 27, wherein said cleaning is at a temperature from about 80° F. to about 110° F.

38. The method of claim 27, wherein the first laundry product and the second laundry product are laundry detergents.

39. The method of claim 27, wherein the indicator material is selected from the group consisting of 1-pyrenyldiazomethane, acetylacetone, diphenylhydrazine, luminarin 4, L-leucine-4-methyl-7-coumarinylamide, 9-anthryldiazomethane, napthyldiazomethane, 4-(2-carbazolylpyrrolidin-1-yl)-7-(N,N-dimethylaminosulfonyl)-2,1,3-benzoxadiazole, N-(bromoacetyl)-N′-[5-(dimethylamino)naphthalene-1-sulfonyl]piperazine, and combinations thereof.

40. The method of claim 27, wherein the indicator material is dissolved in a solvent prior to application.

41. The method of 40, wherein the solvent is a non-aqueous solvent.

42. The method of claim 27, wherein the indicator material is applied to said fabric by spraying.

43. The method of claim 27, wherein the first fabric from (c) and the second fabric from (c) are allowed to remain under ultraviolet light for about 30 minutes before observing.

44. The method of claim 27, wherein the first fabric from (c) and the second fabric from (c) are allowed to remain under ultraviolet light for about 1 hour before observing.

45. The method of claim 27, wherein said observing is using the naked eye.

46. The method of claim 27, wherein said observing is using a spectrophotometric instrument.

47. The method of claim 46, wherein said spectrophotometric instrument is or contains an ultraviolet light source.

48. A method of comparatively analyzing the cleaning efficacy of two laundry products comprising:
(a) applying a soiling substance to a first fabric and a second fabric;
(b) cleaning the first fabric with a first laundry product;
(c) cleaning the second fabric with a second laundry product;
(d) applying an indicator material to the cleaned first fabric;
(e) applying the indicator material used in (d) to the cleaned second fabric;
(f) observing said first and second fabrics, and comparing the color and/or wavelength of the fabric from (d) to the color, fluorescence and/or reflectance at a specific wavelength of the fabric from (e) to determine the cleaning efficacy of the laundry product.

49. The method of claim 48, wherein the soiling substance is selected from the group consisting of sebum, perspiration, a biological soil, tannins, and mixtures thereof.

50. The method of claim 48, wherein the first and second fabric are selected from the group consisting of polyester, cotton, nylon, silk, elastane, and blends thereof.

51. The method of claim 48, wherein the first or second fabric is a consumer-worn garment or a consumer-used fabric.

52. The method of claim 48, wherein the first fabric and the second fabric are the same material.

53. The method of claim 48, wherein the soiling substance on the fabric is invisible to the naked eye.

54. The method of claim 48, wherein the soiling substance has dried on the fabric.

55. The method of claim 48, wherein said cleaning comprises washing in a washing machine.

56. The method of claim 48, wherein said cleaning is at a temperature below about 50° F.

57. The method of claim 48, wherein said cleaning is at a temperature from about 50° F. to about 80° F.

58. The method of claim 48, wherein said cleaning is at a temperature from about 80° F. to about 110° F.

59. The method of claim 48, wherein the first laundry product and the second laundry product are laundry detergents.

60. The method of claim 48, wherein the indicator material is selected from the group consisting of 1-pyrenyldiazomethane, acetylacetone, diphenylhydrazine, luminarin 4, L-leucine-4-methyl-7-coumarinylamide, 9-anthryldiazomethane, napthyldiazomethane, 4-(2-carbazolylpyrrolidin-1-yl)-7-(N,N-dimethylaminosulfonyl)-2,1,3-benzoxadiazole, N-(bromoacetyl)-N′-[5-(dimethylamino)naphthalene-1-sulfonyl]piperazine, and combinations thereof.

61. The method of claim 48, wherein the indicator material is dissolved in a solvent prior to application.

62. The method of 61, wherein the solvent is a non-aqueous solvent.

63. The method of claim 48, wherein the indicator material is applied to said fabric by spraying.

64. The method of claim 48, wherein the fabric from (d) and the fabric from (e) are allowed to remain under ultraviolet light for about 30 minutes before observing.

65. The method of claim 48, wherein the fabric from (d) and the fabric from (e) are allowed to remain under ultraviolet light for about 1 hour before observing.

66. The method of claim 48, wherein said observing is using the naked eye.

67. The method of claim 48, wherein said observing is using a spectrophotometric instrument.

68. The method of claim 64, wherein said spectrophotometric instrument is or contains an ultraviolet light source.

69. A kit for determining the presence of a soiling substance on a fabric comprising:
(a) an indicator material;
(b) a solvent for dissolving the indicator material; and
(c) an apparatus for applying the indicator material to a fabric.

70. The kit of claim 66, further comprising an ultraviolet light source.

71. A kit for determining the cleaning efficacy of a laundry product comprising:
(a) a soiling substance;
(b) an indicator material; and
(c) an apparatus for applying the indicator material to a fabric.

72. The kit of claim 68, further comprising:
(d) a solvent for dissolving the soiling substance; and
(e) a solvent for dissolving the indicator material.

73. The kit of claim 68, further comprising an ultraviolet light source.

74. The kit of claim 67 or claim 70, wherein said ultraviolet light source is a hand-held ultraviolet light.
